(19) United States
(12) Patent Application Publication
(10) Pub. No.: US 2006/0092521 A1
(43) Pub. Date: May 4, 2006

(54) Three dimensional dial for vehicle

(75) Inventors: Vyacheslav Birman, Rochester Hills, MI (US); Richard D. Sanders, Clarkston, MI (US); Adam M. Drury, West Bloomfield, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/221,629

(22) Filed: Sep. 8, 2005

Related U.S. Application Data
(60) Provisional application No. 60/623,133, filed on Oct. 28, 2004.

(51) Int. Cl. G09G 5/00

(52) U.S. Cl. 359/630; 345/7

(57) ABSTRACT

A vehicle instrument panel assembly includes a first symbol having a first importance and a second symbol having a second importance that is less than the first importance. A lenticular sheet between an observer and the first and second symbols produces a first stereoscopic symbol that corresponds to the first symbol and a second stereoscopic symbol that corresponds to a second symbol. To an observer, the first stereoscopic symbol appears closer than the second stereoscopic symbol.

### CROSS-REFERENCE TO RELATED APPLICATIONS

The application claims priority to U.S. Provisional Application No. 60/623,133, filed on Oct. 28, 2004.

### BACKGROUND OF THE INVENTION

This invention relates to vehicle instrument panels and, more particularly, to an instrument panel assembly having a lenticular surface for providing a three dimensional appearance.

Vehicle instrument panels, such as instrument clusters having a speedometer and a tachometer instrument, display vehicle information to vehicle occupants. Conventional instrument panels include a pointer that moves in response to changing vehicle speed, for example. A dial behind the pointer includes a scale having tick marks and numbers, which indicate the speed of the vehicle to the vehicle occupants. Typically, the dial is fabricated by printing the scale, tick marks, and numbers on a relatively flat, thin sheet and mounting the printed sheet within the instrument panel.

Conventional instrument panels do not convey the importance of selected portions of the scale or tick marks in a desirable manner. The tick marks are often printed in various colors or in various sizes to indicate importance or to distinguish a difference. Primary tick marks that correspond to speed in miles per hour, for example, are often made larger than secondary tick marks that correspond to kilometers per hour. Although differing the color or size of the tick marks is somewhat effective in distinguishing importance, it is often desirable to further distinguish between such tick marks.

Other conventional instrument panels utilize depth to indicate importance or to distinguish a difference. Conventional instrument panels that utilize depth are assembled such that selected portions are physically located closer to the vehicle occupants to indicate importance or to distinguish over other portions that are located physically farther away from the vehicle occupants. Disadvantageously, these conventional assemblies require a significant amount of space in the vehicle because of the depth added to the instrument panel to accommodate the differences in physical locations relative to the vehicle occupants.

Accordingly, there is a need for a compact vehicle instrument panel that provides a three dimensional appearance to communicate relative levels of importance.

### SUMMARY OF THE INVENTION

A vehicle instrument panel according to the present invention includes a dial having two symbols with differing levels of importance. A lenticular surface between the first and second symbols and an observer produces a stereoscopic three-dimensional effect. To an observer viewing the instrument panel, one of the symbols, which has a higher level of importance than the other symbol, appears closer.

In another example, the symbols are printed on a dial surface that is attached to the lenticular surface. A housing supports the lenticular surface and the dial, along with a pointer that defines a plane. The lenticular surface generates a stereoscopic three-dimensional effect such that the symbols appear to be in the plane of the pointer.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 shows an example three-dimensional vehicle instrument panel assembly according to the present invention.

FIG. 2 shows a schematic cross-section of the example vehicle instrument panel assembly shown in FIG. 1.

FIG. 3 shows an alternate view of the instrument panel dial of FIG. 2.

FIG. 4 shows a perspective view of an example lenticular surface.

FIG. 5 shows the stereoscopic images produced by a lenticular surface from images on a dial.

FIG. 6 shows an example concentric pentagon image for generating a three dimensional smooth-sided pentagon emblem.

### DETAILED DESCRIPTION OF THE PREFERRED EMBODIMENT

FIG. 1 illustrates selected portions of a vehicle 10 having an instrument panel 12, such as a vehicle meter cluster that communicates vehicle information to occupants of the vehicle 10. In the illustrated example, the instrument panel 12 includes a speedometer 14 that indicates the speed of the vehicle 10. The speedometer includes a dial surface 16 having numerals 18 that correspond to the vehicle 10 speed, primary tick marks 20 that correspond to miles per hour (m.p.h.), secondary tick marks 22 that correspond to kilometers per hour, and an emblem 23 corresponding to a vehicle maker. Alternatively, the primary tick marks 20 may, for example, correspond to significant speed intervals such as 20, 40, 60 m.p.h., etc. and the secondary tick marks 22 may correspond to speeds between.

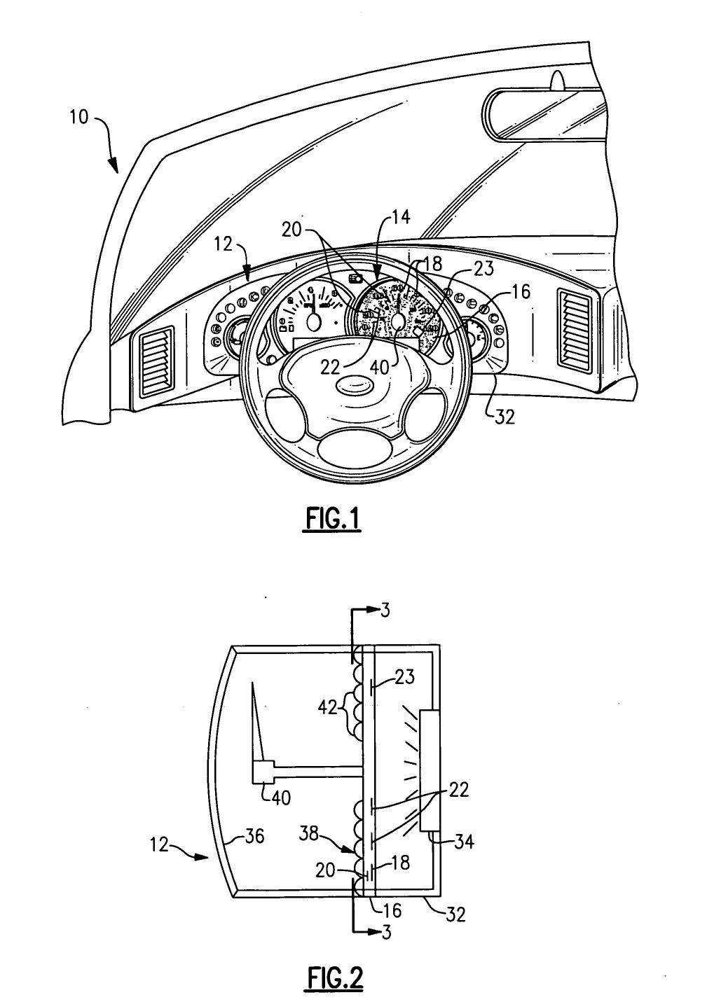

Referring to the selected portion of the instrument panel 12 shown in FIG. 2, the dial 16 is supported by a housing 32. The housing 32 also supports a light source 34 that illuminates the dial 16. A lens 36 protects the instrument panel 12 from the surroundings, such as dust or debris.

The dial 16 is bonded to a lenticular surface 38 in a known manner. The housing 32 supports the dial 16 and lenticular surface 38. A pointer 40 is mounted near the dial 16 and rotates as the speed of the vehicle 10 changes to indicate the vehicle speed. The lenticular surface 38 includes an array of lenticules 42 (e.g., elongated parallel lenses) that operate to generate a three-dimensional effect, as will be described below.

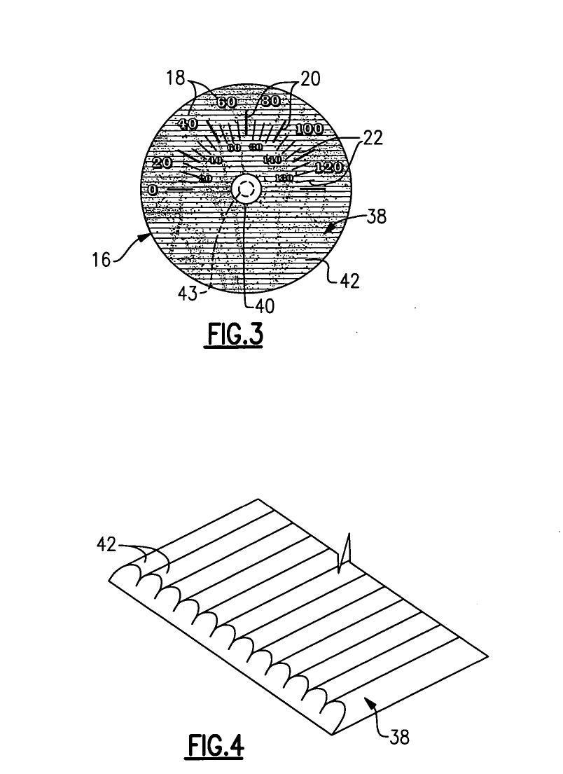

FIG. 3 shows the dial 16 and lenticular surface 38 according to the view indicated in FIG. 2. The dial 16 includes an opening 43 for receiving the pointer 40. The lenticules 42 extend parallel to each other in a generally horizontal direction. It is to be recognized that, although the lenticules 42 are shown in a particular orientation relative to the dial 16, alternative orientations may also be used.

FIG. 4 shows a perspective view of an example lenticular surface 38 having a parallel array of lenticules 42. In this example, each lenticule 42 has a convex shape that functions as a lens to refract light that passes through the lenticular surface 38 to produce a three-dimensional effect.

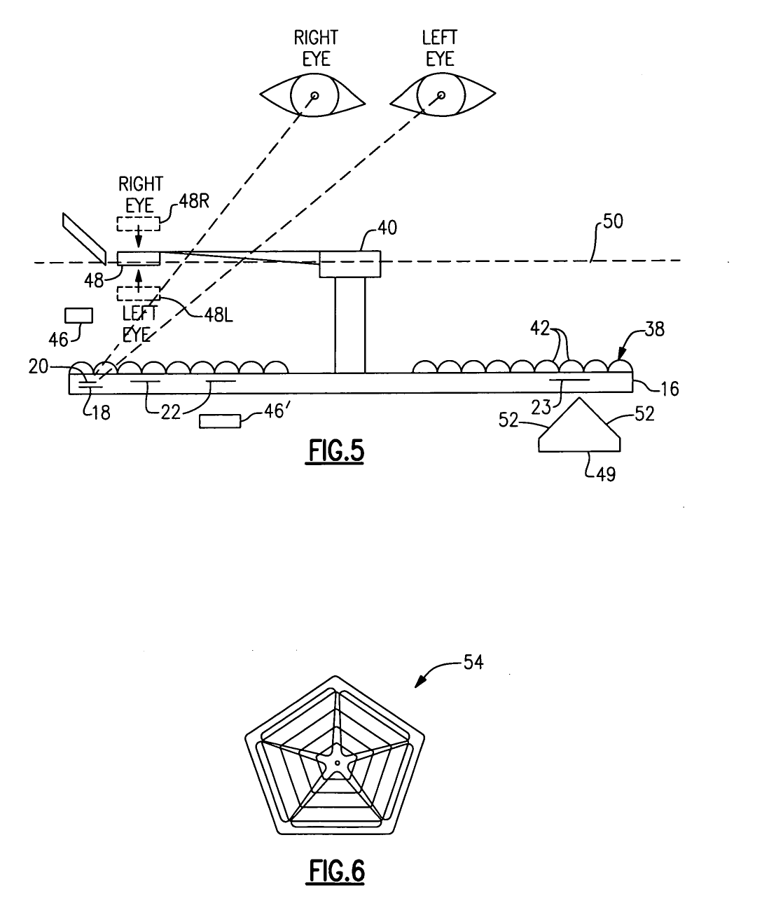

FIG. 5 shows the lenticular surface 38 operating to generate stereoscopic images from the primary tick marks 20, secondary tick marks 22, numerals 18, and emblem 23 on the dial 16. The illustration shows relative positions (as observed by a vehicle occupant having binocular vision from a viewing point) of stereoscopic primary tick marks 44, stereoscopic secondary tick marks 46 (e.g., 46 representing secondary m.p.h. tick marks and 46′ representing k.p.h. tick marks), stereoscopic numerals 48, and a stereoscopic emblem 49. The term stereoscopic as used in this description refers to the use of binocular vision to generate a three-dimensional perspective.

In the illustrated example, the lenticular surface 38 utilizes the binocular vision of an observer, such as a vehicle occupant, to give the appearance that the dial 16 is three-dimensional. In simple terms, the eyes of the observer are spaced apart and each eye sees, for example, the numerals 18 at a slightly different angle. A right eye of the observer sees a first image 48R and a left eye of the observer sees a second image 48L. Normally (i.e., without the lenticular surface 38), the observer's brain forms a composite of the images such that the observer sees only a single image. However, the lenticules 42 of the lenticular surface 38 accentuate the slight angular difference between the observer's eyes such that the composite of the first image 48R and the second image 48L (i.e., the stereoscopic numeral 48) appears to be closer to the observer than the numeral 18. In this manner, the observer views the stereoscopic primary tick marks 44, stereoscopic secondary tick marks 46, and stereoscopic numerals 48 as having a special depth (i.e., having a three-dimensional effect).

In the illustrated example, the primary tick marks 20 are radially outward of the secondary tick marks 22 in the dial 16 relative to a pivot axis A defined by the pointer 40. The radial position of the primary tick marks 20 compared to the radial position of the secondary tick marks 22 results in the observer viewing the primary tick marks 20 at a smaller angle (relative to the dial 16) than the secondary tick marks 22. As a result, the stereoscopic primary tick marks 44 appear closer to the observer than the stereoscopic secondary tick marks 46.

In another example, the primary tick marks 20, secondary tick marks 22, and numerals 18 are printed onto the dial 16. The background of the dial 16 is multi-colored in a marble effect (FIG. 3). The multi-colored marble effect generates a greater stereoscopic effect and may result in the appearance of a greater depth difference between, for example, the stereoscopic primary tick marks 44 and the stereoscopic secondary tick marks 46.

The relative closeness of the stereoscopic primary tick marks 44 communicates to the vehicle occupant a higher level of importance than the secondary tick marks 22, which appear farther away. This provides a benefit of communicating the difference in importance between the primary tick marks 20 and the secondary tick marks 22 without, or in addition to, other methods of differentiating levels of importance (e.g., with the use of color or size).

In the illustration, the pointer 40 defines a plane 50. The stereoscopic primary tick mark 44 and the stereoscopic numerals 48 are within the plane 50 of the pointer 40. This allows a vehicle occupant viewing the instrument panel 12 to easily associate the stereoscopic numerals 48 with the stereoscopic primary tick marks 44 and provides a desirable appearance.

The stereoscopic emblem 49 appears with smoothly sloping sides 52. The smoothly sloping sides result from a concentric pentagon image 54 on the dial 16, as shown in FIG. 6 for example.

The disclosed example provides the benefit of a more compact instrument panel 12 than previously known instrument panels. The dial 16 is attached directly to the lenticular surface 38 in a relatively thin configuration. Further, the generation of the appearance of depth using the lenticular surface 38 allows physical depth in the instrument panel 12 to be eliminated. In one example, this allows the pointer 40 to be moved closer to the dial 16 to save space in the instrument panel 12.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A vehicle instrument panel assembly comprising:
a first symbol having a first importance;
a second symbol having a second importance that is less than the first importance;
a lenticular viewing surface between a viewing point and the first and second symbols that produces a stereoscopic first symbol that corresponds to the first symbol and a stereoscopic second symbol that corresponds to the second symbol, wherein the stereoscopic first symbol is closer to the viewing point than the stereoscopic second symbol.

2. The assembly as recited in claim 1, further comprising a pointer that defines a reference point, and the first symbol is radially outward from said second symbol relative to the reference point.

3. The assembly as recited in claim 1, wherein the lenticular viewing surface comprises a sheet having a lenticular first side and a second side, and the first symbol and the second symbol are on a dial surface that is bonded to the second side.

4. The assembly as recited in claim 3, wherein the dial surface includes a multi-colored background.

5. The assembly as recited in claim 1, wherein the first symbol is a miles per hour speedometer tick mark and the second symbol is a kilometers per hour speedometer tick mark.

6. The assembly as recited in claim 1, wherein the first symbol and the second symbol are two-dimensional images.

7. The assembly as recited in claim 1, wherein the lenticular viewing surface includes a sheet having an array of parallel lenticules.

8. A vehicle instrument panel assembly observable from a viewing point, the vehicle instrument panel comprising:
a first symbol;
a pointer defining a pointer plane near the first symbol; and
a lenticular viewing surface between the pointer and the first symbol that produces a first stereoscopic symbol corresponding to the first symbol, and the first stereoscopic symbol is at least partially in the pointer plane.

9. The assembly as recited in claim 8, further comprising a housing that supports the pointer and the lenticular viewing surface.

10. The assembly as recited in claim 9, further comprising a light source supported by the housing that illuminates the first symbol.

11. The assembly as recited in claim 9, further comprising a lens spaced apart from the pointer.

12. The assembly as recited in claim 8, further comprising a second symbol adjacent to the first symbol, the lenticular viewing surface produces a stereoscopic second symbol that is at least partially in the pointer plane.

13. The assembly as recited in claim 12, wherein the first symbol comprises a number and the second symbol comprises a tick mark that corresponds to the number.

14. A method of communicating relative importance of selected automotive instrument panel symbols, comprising:
(a) generating stereoscopic first symbols a first distance from a viewing point that correspond to preferred importance symbols on an instrument dial; and
(b) generating stereoscopic second symbols a second distance from the viewing point that is different than the first distance, the second distance corresponds to less preferred symbols on the instrument dial.

15. The method as recited in claim 15, including positioning the preferred importance symbols radially outward from the less preferred symbols relative to a pointer.

16. The method as recited in claim 15, including generating the first stereoscopic symbol a closer distance to the viewing point than the second stereoscopic symbol.
